(19) United States
(12) Patent Application Publication
(10) Pub. No.: US 2015/0030853 A1
(43) Pub. Date: Jan. 29, 2015

(54) CROSSLINKABLE HALOGEN-FREE RESIN COMPOSITION, CROSSLINKED MOLDED ARTICLE, INSULATED WIRE AND CABLE

(71) Applicant: Hitachi Metals, Ltd., Tokyo (JP)

(72) Inventors: Makoto IWASAKI, Hitachi (JP); Mitsuru HASHIMOTO, Hitachi (JP)

(21) Appl. No.: 14/327,471

(22) Filed: Jul. 9, 2014

(30) Foreign Application Priority Data
Jul. 23, 2013 (JP) 2013-153003

(51) Int. Cl. H01B 3/44; H01B 3/02; H01B 7/295; C08L 31/04

(52) U.S. Cl. CPC H01B 3/441; C08L 31/04; H01B 3/02; H01B 7/295; C08L 2205/025; C08L 2205/03; C08L 2201/02; C08L 2203/202
USPC 428/389; 524/436; 524/437

(57) ABSTRACT

A crosslinkable halogen-free resin composition includes a base polymer including at least one type of ethylene-vinyl acetate copolymer (EVA) and an acid-modified polyolefin resin having a glass-transition temperature (Tg) as measured by DSC of not more than −55° C. at a mass ratio of 70:30 to 99:1, and a metal hydroxide included in an amount of 100 to 250 parts by mass per 100 parts by mass of the base polymer. The at least one type of EVA has a melting temperature (Tm) as measured by DSC of not less than 70° C. The base polymer includes 25 to 50 mass % of a vinyl acetate (VA).

The present application is based on Japanese patent application No. 2013-153003 filed on Jul. 23, 2013, the entire contents of which are incorporated herein by reference.

### BACKGROUND OF THE INVENTION

1. Field of the Invention

The invention relates to a crosslinkable halogen-free resin composition which is flame retardant, a crosslinked molded article derived from the resin composition, and an insulated wire and a cable (especially, automotive insulated wire and cable) each provided with a covering layer including the crosslinked molded article.

2. Description of the Related Art

Flame-retardant resin compositions not including halogen compounds (halogen-free) are needed to be used as insulating materials of insulated wires and cables. Insulated wires and cables used especially in vehicles such as railway vehicles or automobiles are further needed to be excellent in fuel resistance and cold resistance.

For example, a composition in which a metal hydroxide as a halogen-free flame retardant, such as magnesium hydroxide, is added to a base polymer formed by mixing an ethylene-vinyl acetate copolymer with a polyolefin-based resin is known as a halogen-free flame-retardant resin composition used for insulated wire and cable (see e.g. JP-A-2010-097881).

The halogen-free flame-retardant resin composition does not produce poisonous gas such as hydrogen chloride or dioxin when being burnt, which prevents toxic gas production and resulting secondary disaster etc. in the event of fire, and also, no problem arises even if incinerated for disposal.

### SUMMARY OF THE INVENTION

In order to have a high flame retardancy to suppress the propagation of flame in the event of fire, it is generally necessary to add a large amount of a halogen-free flame retardant. However, adding a large amount of the flame retardant may cause a decrease in mechanical characteristics, resulting in failure to obtain the intended wires.

The fuel resistance may be improved by using a high-polarity polymer. However, due to the high-polarity polymer, the cold resistance may lower. Furthermore, if it is processed into pellets, a grinding process may be required since the pellets can adhere to each other at room temperature.

It is an object of the invention to provide a crosslinkable halogen-free resin composition which has flame retardancy as well as excellent mechanical characteristics and is to be a material of a crosslinked molded article excellent in fuel resistance, cold resistance and storage stability at room temperature, a crosslinked molded article derived from the resin composition, as well as an insulated wire and a cable (especially, automotive insulated wire and cable) each provided with a covering layer including the crosslinked molded article.

(1) According to one embodiment of the invention, a crosslinkable halogen-free resin composition comprises:

a base polymer including at least one type of ethylene-vinyl acetate copolymer (EVA) and an acid-modified polyolefin resin having a glass-transition temperature (Tg) as measured by DSC of not more than −55° C. at a mass ratio of 70:30 to 99:1; and

a metal hydroxide included in an amount of 100 to 250 parts by mass per 100 parts by mass of the base polymer,

wherein the at least one type of EVA has a melting temperature (Tm) as measured by DSC of not less than 70° C., and

wherein the base polymer includes 25 to 50 mass % of a vinyl acetate (VA).

In the above embodiment (1) of the invention, the following modifications and changes can be made.

(i) The at least one type of EVA has a melt mass-flow rate (MFR) of not less than 6 g/10 min.

(ii) The metal hydroxide comprises a magnesium hydroxide or aluminum hydroxide.

(iii) The metal hydroxide is treated with a silane or fatty acid.

(2) According to another embodiment of the invention, a crosslinked molded article formed by crosslinking the crosslinkable halogen-free resin composition according to the above embodiment (1).
(3) According to another embodiment of the invention, an insulated wire comprises an insulation layer comprising the crosslinked molded article according to the above embodiment (2).
(4) According to another embodiment of the invention, a cable comprises the insulated wire according to the above embodiment (3).
(5) According to another embodiment of the invention, a cable comprises a sheath comprising the crosslinked molded article according to claim the above embodiment (2).

### EFFECTS OF THE INVENTION

According to one embodiment of the invention, a crosslinkable halogen-free resin composition can be provided which has flame retardancy as well as excellent mechanical characteristics and is to be a material of a crosslinked molded article excellent in fuel resistance, cold resistance and storage stability at room temperature, a crosslinked molded article derived from the resin composition, as well as an insulated wire and a cable (especially, automotive insulated wire and cable) each provided with a covering layer including the crosslinked molded article.

### BRIEF DESCRIPTION OF THE DRAWINGS

Next, the present invention will be explained in more detail in conjunction with appended drawings, wherein:

FIG. 1 is a cross sectional view showing an embodiment of an insulated wire in the present invention; and

FIG. 2 is a cross sectional view showing an embodiment of a cable in the invention.

### DETAILED DESCRIPTION OF THE PREFERRED EMBODIMENT

An embodiment of a crosslinkable halogen-free resin composition, a crosslinked molded article, an insulated wire and a cable of the invention will be specifically described below.

Crosslinkable Halogen-Free Resin Composition

A crosslinkable halogen-free resin composition in the embodiment of the invention includes a base polymer in which one or more types of ethylene-vinyl acetate copolymers (EVAs) and an acid-modified polyolefin resin having a glass-transition temperature (Tg) as measured by DSC of not more than −55° C. are included at a ratio (a mass ratio) of the former to the latter=70:30 to 99:1; and a metal hydroxide included in an amount of 100 to 250 parts by mass per 100 parts by mass of the base polymer, wherein at least one of the EVAs has a melting temperature (Tm) as measured by DSC of not less than 70° C., and a vinyl acetate content (VA content) in the base polymer is 25 to 50 mass %.

EVA

The base polymer in the crosslinkable halogen-free resin composition includes one or more types of ethylene-vinyl acetate copolymers (EVAs). It is exemplary that one to three types of EVAs, more exemplarily, one or two types of EVAs, be included.

At least one of such EVAs has a melting temperature (Tm) as measured by DSC of not less than 70° C. One or two EVAs having Tm of not less than 70° C. are exemplarily included. When all of the included EVAs have Tm of less than 70° C., crystallinity is low, fuel resistance decreases and it is difficult to pelletize since storage stability at room temperature also decreases. Although EVAs having high Tm tend to have a small vinyl acetate content (VA content), the VA content only needs to be 25 to 50 mass % of the entire base polymer as described later and the upper limit of Tm is thus not specifically defined. In order to easily adjust the VA content in the entire base polymer to within a range of 25 to 50 mass %, the upper limit of Tm is exemplarily not more than 100° C., more exemplarily 95° C., and further exemplarily 90° C.

In addition, in the present embodiment, it is exemplary that at least one of EVAs included in the base polymer have a melt mass-flow rate (MFR) of not less than 6 g/10 min. It is exemplary that one or two types of EVAs having MFR of not less than 6 g/10 min be included. It is further exemplary that EVAs having MFR of not less than 6 g/10 min also have Tm of not less than 70° C. EVA having MFR of not less than 6 g/10 min provides high melt flowability and the best productivity.

Acid-Modified Polyolefin Resin

The base polymer in the crosslinkable halogen-free resin composition in the present embodiment includes an acid-modified polyolefin resin having a glass-transition temperature (Tg) as measured by DSC of not more than −55° C. Tg of the acid-modified polyolefin resin is determined to be not more than −55° C. in the present embodiment since cold resistance decreases at Tg of more than −55° C.

For the acid-modified polyolefin resin used in the present embodiment, very low-density polyethylene, ethylene-methyl acrylate copolymer, ethylene-ethyl acrylate copolymer, ethylene-butene-1 copolymer, ethylene-hexene-1 copolymer and ethylene-octene-1 copolymer, etc., are listed as a polyolefin material, and maleic acid, maleic acid anhydride and fumaric acid, etc., are listed as an acid. These acid-modified polyolefin resins can be used alone or in a combination thereof

Amounts of Components Included in Base Polymer

In the base polymer of the crosslinkable halogen-free resin composition, the EVA(s) and the acid-modified polyolefin resin are included so that a ratio (a mass ratio) of the former to the latter is 70:30 to 99:1. Polarity is low and fuel resistance decreases when the proportion of the EVA included is less than 70, while polarity is high, a glass-transition temperature is increased and cold resistance decreases when the more than 99. Therefore, the proportion of the EVA included is determined to be 70 to 99. Meanwhile, the proportion of the acid-modified polyolefin resin included is determined to be 30 to 1 since adhesion of polymer to filler is low and also cold resistance and fuel resistance decrease when less than 1, while strong adhesion of polymer to filler causes a decrease in elongation when more than 30.

In addition, the vinyl acetate content (VA content) in the base polymer is 25 to 50 mass %.

The VA content in the base polymer is derived from the following formula (1) when the number of types of polymers used for the base polymer is 1 or 2 or 3 . . . or k . . . or n.

$$( VA content in Base polymer ) = {\sum }_{k = 1}^{n} {X}_{k} {Y}_{k} \qquad ( 1 )$$

In the formula (1), X is the VA content in Polymer k (mass %), Y is the percentage of Polymer k in the entire base polymer and k is a natural number.

In the present embodiment, flame retardancy is not sufficient when the VA content in the base polymer is less than 25 mass %. On the other hand, when the VA content is higher than 50 mass %, a crushing process is required because of blocking of pellets formed of the resin composition in the embodiment, which causes a decrease in workability.

Although polymer components other than the EVAs and the acid-modified polyolefin resin may be included in the base polymer in the present embodiment as long as the base polymer exerts its effects, the amount of the EVAs and the acid-modified polyolefin resin is exemplarily not less than 90 mass %, more exemplarily not less than 95 mass %, further exemplarily 100 mass % (i.e., the base polymer is composed of only EVAs and the acid-modified polyolefin resin).

Metal Hydroxide

The crosslinkable halogen-free resin composition in the present embodiment of the invention includes 100 to 250 parts by mass of metal hydroxide per 100 parts by mass of the base polymer. Sufficient flame retardancy is not obtained when the content of the metal hydroxide is less than 100 parts by mass while elongation decreases when more than 250 parts by mass.

The metal hydroxide used in the present embodiment can be magnesium hydroxide, aluminum hydroxide, calcium hydroxide, and these metal hydroxides with dissolved nickel. These hydroxides can be used alone or in a combination of two or more. As compared to calcium hydroxide of which endothermic quantity at the time of decomposition is about 1000 J/g, endothermic quantity of magnesium hydroxide and aluminum hydroxide is as high as to 1500 to 1600 J/g. Therefore, it is exemplary to use magnesium hydroxide or aluminum hydroxide.

In addition, it is exemplary that these metal hydroxides be surface-treated with, e.g., a silane coupling agent, a titanate-based coupling agent, fatty acid such as stearic acid, fatty acid salt such as stearate, or fatty acid metal salt such as calcium stearate since it is easy to control mechanical characteristics (a balance between tensile strength and elongation). In addition, other metal hydroxides may be added in an appropriate amount.

Other Additives

To the crosslinkable halogen-free resin composition in the present embodiment of the invention, it is possible, if necessary, to add additives such as antioxidants, lubricants, softeners, plasticizers, inorganic fillers, compatibilizing agents, stabilizers, carbon black and colorants in addition to the above-mentioned metal hydroxides. In addition, flame-retardant aids may be added within a range not impairing characteristics of the invention to further improve performance.

Crosslinked Molded Article

A crosslinked molded article in the present embodiment of the invention is obtained by crosslinking the crosslinkable halogen-free resin composition in the embodiment of the invention.

Cross-Linking Method

One of the methods of crosslinking the crosslinkable halogen-free resin composition in the embodiment of the invention is a radiation-crosslinking method in which cross-linking is performed after molding by exposure to an electron beam or radiation, etc. When using the radiation-crosslinking method, a crosslinking aid is pre-mixed to the crosslinkable halogen-free resin composition. For example, trimethylolpropane triacrylate (TMPT) and triallyl isocyanurate (TAIC (trademark)) are suitable as the crosslinking aid.

Alternatively, a chemical cross-linking method in which cross-linking is performed by heating after molding may be used. When using the chemical cross-linking method, a cross-linking agent is pre-mixed to the crosslinkable halogen-free resin composition. The cross-linking agent is not specifically limited as long as it is an organic peroxide. Examples thereof include 1,3-bis(2-t-butylperoxyisopropyl)benzene and dicumyl peroxide (DCP), etc.

Intended Use

The crosslinked molded article obtained by crosslinking the crosslinkable halogen-free resin composition in the embodiment of the invention has flame retardancy as well as excellent mechanical characteristics and is also excellent in fuel resistance, cold resistance and storage stability at room temperature, and thus can be suitably used for insulation layers of insulated wires or sheaths of cables. It is particularly suitable for automotive insulated wires and automotive cables.

Insulated Wire

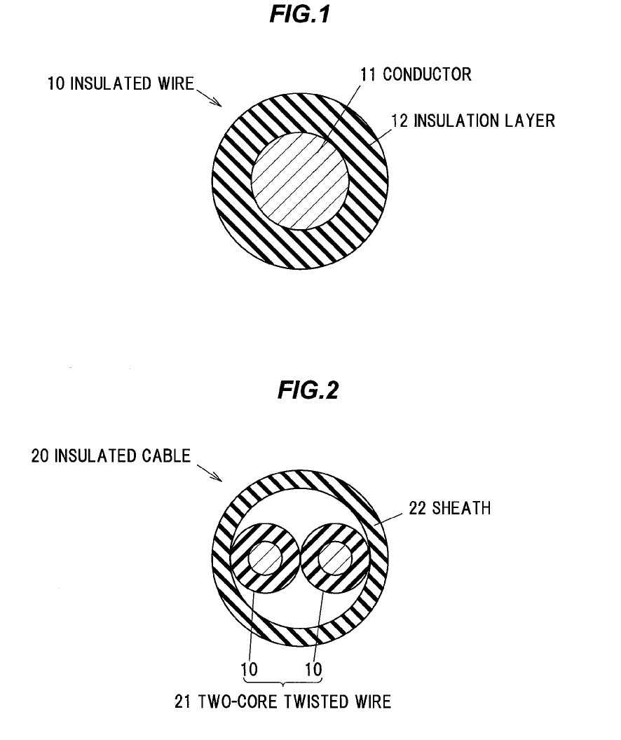

FIG. 1 is a cross sectional view showing an embodiment of an insulated wire in the invention.

As shown in FIG. 1, an insulated wire 10 in the present embodiment is provided with a conductor 11 formed of a general-purpose material, e.g., tin-plated copper, etc., and an insulation layer 12 formed on an outer periphery of the conductor 11.

The insulation layer 12 is formed of the crosslinked molded article obtained by crosslinking the crosslinkable halogen-free resin composition in the embodiment of the invention.

In the present embodiment, the insulation layer may be a single layer or may have a multilayer structure. Specific examples of the multilayer structure include a structure obtained by extruding and coating a polyolefin resin as layers other than the outermost layer and then extruding and coating the crosslinkable halogen-free resin composition as the outermost layer. Examples of the polyolefin resin include low-density polyethylene, EVA, ethylene ethyl acrylate copolymer, ethylene methyl acrylate copolymer, ethylene-glycidyl methacrylate copolymer and maleic anhydride polyolefin, etc., which can be used alone or as a mixture of two or more. A separator or a braid, etc., may be further provided, if required.

Rubber materials are also applicable as a material used for insulation layers other than the outermost layer. Examples thereof include ethylene-propylene copolymer rubber (EPR), ethylene-propylene-diene terpolymer rubber (EPDM), acrylonitrile butadiene rubber (NBR), hydrogenated NBR (HNBR), acrylic rubber, ethylene-acrylic ester copolymer rubber, ethylene-octene copolymer rubber (EOR), ethylene-vinyl acetate copolymer rubber, ethylene-butene-1 copolymer rubber (EBR), butadiene-styrene copolymer rubber (SBR), isobutylene-isoprene copolymer rubber (IIR), block copolymer rubber having a polystyrene block, urethane rubber and phosphazene rubber, etc., which can be used alone or as a mixture of two or more.

In addition, the material is not limited to the polyolefin resins and rubber materials listed above, and is not specifically limited as long as insulation properties are obtained.

Cable

FIG. 2 is a cross sectional view showing an embodiment of a cable in the invention.

As shown in FIG. 2, a cable 20 in the present embodiment is provided with a two-core twisted wire 21 formed by twisting two insulated wires 10 in the present embodiment and a sheath 22 formed on an outer periphery of the two-core twisted wire 21. A single-core wire or a multi-core twisted wire other than two-core may be used instead of the two-core twisted wire.

The sheath 22 is formed of the crosslinked molded article obtained by crosslinking the crosslinkable halogen-free resin composition described above.

In the present embodiment, the sheath may be a single layer or may have a multilayer structure. Specific examples of the multilayer structure include a structure obtained by extruding and coating a polyolefin resin as layers other than the outermost layer and then extruding and coating the crosslinkable halogen-free resin composition as the outermost layer. Examples of the polyolefin resin include low-density polyethylene, EVA, ethylene ethyl acrylate copolymer, ethylene methyl acrylate copolymer, ethylene-glycidyl methacrylate copolymer and maleic anhydride polyolefin, etc., which can be used alone or as a mixture of two or more. A separator or a braid, etc., may be further provided, if required.

Although the cable using the insulated wire 10 in the present embodiment is shown an example, it is also possible to use an insulated wire formed of general-purpose materials. Insulated wires formed of general-purpose materials are used in Examples described below.

### EXAMPLES

The cable of the invention will be further specifically described below in reference to Examples. It should be noted that the following examples are not intended to limit the invention in any way.

### Examples 1 to 6 and Comparative Examples 1 to 8

The cable shown in FIG. 2 was made as follows.

(1) Ethylene-propylene rubber as an insulation layer was extruded at 150° C. to cover each conductor (19 strands×0.18 mm diameter) using a 65-mm extruder so as to have an outer diameter of 1.4 mm and was then cross-linked by electron beam irradiation of 10 Mrad, thereby making insulated wires. Then, a two-core twisted wire was prepared by twisting two of the obtained insulated wires.

(2) Components shown in Table 1 or 2 were mixed and kneaded by a pressure kneader at a start temperature of 40° C. and an end temperature of 200° C. and then formed into pellets (pelletized), thereby obtaining a sheath material.

(3) The obtained sheath material was extruded at 120° C. to cover the two-core twisted wire prepared in the above step (1) using a 90-mm extruder so as to have an outer diameter of 4.4 mm and was then cross-linked by electron beam irradiation of 4 Mrad, thereby making a cable.

Each of the obtained cables was evaluated by the following evaluation tests. Tables 1 and 2 show the evaluation results.

Evaluation Tests

(1) Storage Stability at Room Temperature

Two paper bags of 420 mm×820 mm each packed with 20 kg of the sheath material formed into pellets (pelletized) in the step (2) of the cable manufacturing process were stacked and kept in a constant-temperature oven at 40° C. for 240 hours. After that, the pellets were poured on a tray and blocking of the pellets was checked. Pellets without blocking were evaluated as “◯ (passed the test)” and those with blocking were evaluated as “x (failed the test)”.

(2) Tensile Test

The sheath was peeled off from the obtained cable and was subjected to the tensile test in accordance with EN 60811-1-1. The target values were not less than 10 MPa for tensile strength and not less than 125% for elongation. The samples achieved the target value or more were regarded as “◯ (passed)” and those below the target value were regarded as “x (failed)”.

(3) Fuel Resistance Test

The sheath was peeled off from the obtained cable and was subjected to the fuel resistance test in accordance with EN 60811-1-3. In detail, the sheath was immersed in fuel-resistance-test oil IRM 903, was heated in a constant-temperature oven at 70° C. for 168 hours and was then left at room temperature for about 16 hours. Then, a tensile test was conducted and a value after oil immersion and heating with respect to the initial value (percentage of retention) was evaluated. For tensile strength retention, not less than 70% was regarded as “passed (◯)” and less than 70% was regarded as “failed (x)”. Meanwhile, for elongation retention, not less than 60% was regarded as “passed (◯)” and less than 60% was regarded as “failed (x)”.

(4) Cold Resistance Test

The obtained cables were subjected to a bending test at −40° C. in accordance with EN 60811-1-4 8.1. The cables without cracks after winding were regarded as “passed (◯)” and those with cracks were regarded as “failed (x)”.

(5) Flame-Retardant Test

The obtained cables were subjected to a vertical flame test in accordance with EN 60332-1-2. The cables failed the test (x) when a distance between a lower edge of an upper support member and an upper edge of the carbonized portion after extinguishing was less than 50 mm, and the cables passed the test (◯) when the distance was not less than 50 mm.

Overall Evaluation

For overall evaluation, the cables which passed all tests were evaluated as “passed (◯)” and the cables which failed any of the tests were evaluated as “failed (x)”.

TABLE 1
Examples (mix amount: parts by mass)

| | examples | | | | | |
|---|---|---|---|---|---|---|
| | Examples | | | | | |
| Items | 1 | 2 | 3 | 4 | 5 | 6 |
| EVA (Tm: 89° C., MFR: 15 g/10 min, VA content: 14 wt %)*¹ | 20 | 64 | | 20 | | 20 |
| EVA (Tm: 72° C., MFR: 6 g/10 min, VA content: 28 wt %)*² | | | 70 | | 5 | |
| EVA (Tm: less than 70° C., MFR: 100 g/10 min, VA content: 46 wt %)*³ | 50 | 35 | 15 | 50 | | 50 |
| EVA (Tm: less than 70° C., MFR: 2.5 g/10 min, VA content: 46 wt %)*⁴ | | | | | 94 | |
| Acid-modified polyolefin (Tm: 66° C., Tg: not more than −55° C.)*⁵ | 30 | 1 | 15 | 30 | 1 | 30 |
| Silane-treated magnesium hydroxide*⁶ | 80 | 80 | 80 | 50 | 100 | |
| Fatty acid-treated magnesium hydroxide*⁷ | 120 | 120 | 120 | 50 | 150 | |
| Silane-treated aluminum hydroxide*⁸ | | | | | | 100 |
| Fatty acid-treated aluminum hydroxide*⁹ | | | | | | 80 |
| Trimethylolpropane triacrylate*¹⁰ | 4 | 4 | 4 | 4 | 4 | 4 |
| VA content in Base polymer (wt %) | 25.8 | 25.1 | 26.5 | 25.8 | 44.6 | 25.8 |
| Storage stability at room temperature | ◯ | ◯ | ◯ | ◯ | ◯ | ◯ |
| Tensile strength (MPa) | 13.4 | 11.4 | 10.7 | 12.1 | 10.2 | 12.5 |
| Evaluation | ◯ | ◯ | ◯ | ◯ | ◯ | ◯ |
| Elongation (%) | 127 | 317 | 213 | 303 | 125 | 187 |
| Evaluation | ◯ | ◯ | ◯ | ◯ | ◯ | ◯ |
| Fuel resistance: Tensile strength retention (%) | 89 | 70 | 80 | 83 | 79 | 82 |
| Evaluation | ◯ | ◯ | ◯ | ◯ | ◯ | ◯ |
| Fuel resistance: Elongation retention (%) | 95 | 62 | 94 | 92 | 92 | 91 |
| Evaluation | ◯ | ◯ | ◯ | ◯ | ◯ | ◯ |
| Cold resistance test | ◯ | ◯ | ◯ | ◯ | ◯ | ◯ |
| Flame-retardant test | ◯ | ◯ | ◯ | ◯ | ◯ | ◯ |
| Overall Evaluation | ◯ | ◯ | ◯ | ◯ | ◯ | ◯ |

*¹Eva Flex EV550 from Du Pont-Mitsui Polychemicals
*²Eva Flex EV260 from Du Pont-Mitsui Polychemicals
*³Eva Flex EV45X from Du Pont-Mitsui Polychemicals
*⁴Eva Flex EV45LX from Du Pont-Mitsui Polychemicals
*⁵TAFMER MH7020 from Mitsui chemicals
*⁶MAGNIFIN H10A from Albemarle Corporation
*⁷MAGNIFIN H10C from Albemarle Corporation
*⁸BF013STV from Nippon Light Metal
*⁹HIGILITE H42S from Showa Denko
*¹⁰TMPT from Shin-Nakamura Chemical

TABLE 2
Comparative Examples (mix amount: parts by mass)

| | examples | | | | | | | |
|---|---|---|---|---|---|---|---|---|
| | Comparative Examples | | | | | | | |
| Items | 1 | 2 | 3 | 4 | 5 | 6 | 7 | 8 |
| EVA (Tm: 89° C., MFR: 15 g/10 min, VA content: 14 wt %)*¹ | 69 | | 10 | | 64 | 64 | 64 | |
| EVA (Tm: 72° C., MFR: 6 g/10 min, VA content: 28 wt %)*² | | | | 100 | | | | |
| EVA (Tm: 62° C., MFR: 1 g/10 min, VA content: 33 wt %)*¹¹ | | | | | | | | 90 |
| EVA (Tm: less than 70° C., MFR: 100 g/10 min, VA content: 46 wt %)*³ | 30 | 10 | | | 35 | 35 | 35 | |
| EVA (Tm: less than 70° C., MFR: 5.1 g/10 min, VA content: 80 wt %)*¹² | | 60 | 55 | | | | | |
| Acid-modified polyolefin (Tm: 66° C., Tg: not more than −55° C.)*⁵ | 1 | 30 | 35 | | 1 | 1 | | |
| Acid-modified polyolefin (Tm: 66° C., Tg: −50° C.)*¹³ | | | | | | | 1 | 10 |
| Silane-treated magnesium hydroxide*⁶ | 100 | 100 | 100 | 100 | 40 | 110 | 100 | 100 |
| Fatty acid-treated magnesium hydroxide*⁷ | 100 | 100 | 100 | 100 | 50 | 150 | 150 | 100 |
| Trimethylolpropane triacrylate*¹⁰ | 4 | 4 | 4 | 4 | 4 | 4 | 4 | 4 |
| VA content in Base polymer (wt %) | 23.5 | 52.6 | 45.4 | 28 | 25.1 | 25.1 | 25.1 | 29.7 |
| Storage stability at room temperature | ◯ | X | ◯ | ◯ | ◯ | ◯ | ◯ | X |
| Tensile strength (MPa) | 11.8 | 15.6 | 16.2 | 12.5 | 12.3 | 9.5 | 10.2 | 13.5 |
| Evaluation | ◯ | ◯ | ◯ | ◯ | ◯ | X | ◯ | ◯ |
| Elongation (%) | 320 | 123 | 90 | 280 | 290 | 90 | 130 | 230 |
| Evaluation | ◯ | ◯ | X | ◯ | ◯ | X | ◯ | ◯ |
| Fuel resistance: Tensile strength retention (%) | 89 | 95 | 94 | 68 | 79 | 85 | 78 | 69 |
| Evaluation | ◯ | ◯ | ◯ | X | ◯ | ◯ | ◯ | X |
| Fuel resistance: Elongation retention (%) | 95 | 93 | 98 | 59 | 92 | 99 | 90 | 50 |
| Evaluation | ◯ | ◯ | ◯ | X | ◯ | ◯ | ◯ | X |
| Cold resistance test | ◯ | ◯ | ◯ | X | ◯ | ◯ | X | ◯ |
| Flame-retardant test | X | ◯ | ◯ | ◯ | X | ◯ | ◯ | ◯ |
| Overall Evaluation | X | X | X | X | X | X | X | X |

*^{1,2,3,5,6,7,10}Same as Examples
*¹¹Eva Flex EV170 from Du Pont-Mitsui Polychemicals
*¹²Levapren from LANXESS, MFR: 5.1 g/min (Conditions - temperature: 190° C., load: 2.16 kg)
*¹³OREVAC G 18211 from ARKEMA

As shown in Table 1, Examples 1 to 6 passed all tests (all “◯”) and the overall evaluation is thus rated as “◯”.

As shown in Table 2, Comparatives Example 1 in which the VA content in the base polymer was less than 25 mass % failed the flame test. Therefore, the overall evaluation is rated as “x”.

In Comparatives Example 2, since EVA having Tm of not less than 70° C. was not used and the VA content in the base polymer was more than 50 mass %, blocking occurred in the test of storage stability at room temperature. Therefore, the overall evaluation is rated as “x”.

In Comparatives Example 3, since the amount of the acid-modified polyolefin resin was more than the defined amount, elongation characteristics were not sufficient. Therefore, the overall evaluation is rated as “x”.

In Comparatives Example 4, since the acid-modified polyolefin resin was not added, cracks were generated in the cold resistance test. Therefore, the overall evaluation is rated as “x”.

Comparatives Example 5, in which the added amount of the flame retardant (surface-treated magnesium hydroxide or aluminum hydroxide) was small, failed the flame test. Therefore, the overall evaluation is rated as “x”.

Comparatives Example 6, in which the added amount of the flame retardant (surface-treated magnesium hydroxide or aluminum hydroxide) was large, failed the test of tensile characteristics. Therefore, the overall evaluation is rated as “x”.

In Comparatives Example 7, since Tg of the acid-modified polyolefin resin was high, cracks were generated in the cold resistance test. Therefore, the overall evaluation is rated as “x”.

Comparatives Example 8, in which the Tm of EVA in the base polymer was less than 70° C., failed the tests of storage stability at room temperature and fuel resistance. Therefore, the overall evaluation is rated as “x”.

The following was found from the above results. It is not possible to obtain sufficient flame retardancy when the VA content in the base polymer is less than 25 mass % while blocking occurs during storage at room temperature when more than 50 mass %. Meanwhile, storage stability at room temperature and flame retardancy are not sufficient when the base polymer does not include EVA having Tm of not less than 70° C. Cold resistance is not sufficient when the acid-modified polyolefin resin having Tg of not more than −55° C. is not added while excessive addition thereof causes a decrease in elongation. Flame retardancy is not sufficient when the flame retardant is less than 100 parts by mass while sufficient tensile characteristics are not obtained when more than 250 parts by mass. When the acid-modified polyolefin resin having Tg of higher than −55° C. is used, cold resistance is not sufficient. Therefore, EVA having Tm of not less than 70° C. needs to be used and the acid-modified polyolefin resin having Tg of higher than −55° C. is essential. The ratio of EVA:Acid-modified polyolefin resin needs to be 70:30 to 99:1 (mass ratio). In addition, VA in the base polymer needs to be 25 to 50 mass % and the metal hydroxide needs to be added in an amount of 100 to 250 parts by mass per 100 parts by mass of the base polymer.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A crosslinkable halogen-free resin composition, comprising:
a base polymer including at least one type of ethylene-vinyl acetate copolymer (EVA) and an acid-modified polyolefin resin having a glass-transition temperature (Tg) as measured by DSC of not more than −55° C. at a mass ratio of 70:30 to 99:1; and
a metal hydroxide included in an amount of 100 to 250 parts by mass per 100 parts by mass of the base polymer,
wherein the at least one type of EVA has a melting temperature (Tm) as measured by DSC of not less than 70° C., and
wherein the base polymer includes 25 to 50 mass % of a vinyl acetate (VA).

2. The crosslinkable halogen-free resin composition according to claim 1, wherein the at least one type of EVA has a melt mass-flow rate (MFR) of not less than 6 g/10 min.

3. The crosslinkable halogen-free resin composition according to claim 1, wherein the metal hydroxide comprises a magnesium hydroxide or aluminum hydroxide.

4. The crosslinkable halogen-free resin composition according to claim 1, wherein the metal hydroxide is treated with a silane or fatty acid.

5. A crosslinked molded article formed by crosslinking the crosslinkable halogen-free resin composition according to claim 1.

6. An insulated wire, comprising an insulation layer comprising the crosslinked molded article according to claim 5.

7. A cable, comprising the insulated wire according to claim 6.

8. A cable, comprising a sheath comprising the crosslinked molded article according to claim 5.
